(19) United States
(12) Patent Application Publication
(10) Pub. No.: US 2005/0210121 A1
(43) Pub. Date: Sep. 22, 2005

(54) Satellite anticipatory bandwith acceleration

(75) Inventors: Kirk Steven Taylor, San Diego, CA (US); Ricardo Jorge Lopez, San Marcos, CA (US); Jack Steenstra, San Diego, CA (US)

Correspondence Address: Qualcomm Incorporated;Patents Department, 5775 Morehouse Drive, San Diego, CA, 92121-1714, US

(73) Assignee: QUALCOMM Incorporated

(21) Appl. No.: 10/931,308

(22) Filed: Aug. 31, 2004

Related U.S. Application Data
(60) Provisional application No. 60/555,606, filed on Mar. 22, 2004.

(51) Int. Cl. G06F 15/16

(52) U.S. Cl. 709/218

(57) ABSTRACT

A content gathering system for providing a content object to a web browser is disclosed. The content gathering system includes customer premises equipment (CPE), a gateway remote to the CPE, and a satellite link that couples them together. The CPE includes a first cache, and the gateway includes a second cache. In at least one of the CPE and the gateway, a parameterization filter that masks differences between a first URI of the content object and a second URI of a cached content object that is stored in at least one of the first or second cache.

This application claims the benefit of and is a non-provisional of U.S. Application Ser. No. 60/555,606 filed on Mar. 22, 2004, which is incorporated by reference in its entirety.

This application is related to U.S. Patent Application, filed on the same date as the present application, entitled “HTTP ACCELERATION OVER A NETWORK LINK” (temporarily referenced by Attorney Docket No. 04036, which is incorporated by reference in its entirety.

### BACKGROUND OF THE DISCLOSURE

This disclosure relates in general to web browsing and, more specifically, but not by way of limitation, to enhancing performance of supplying content for web browsing.

A broadband geosynchronous satellite imposes a propagation delay to any transport of approximately 250 ms. This has the obvious implication that any communication on the part of a sender is delayed a quarter second before a receiver can react to and respond to the given communication. The TCP/IP protocol requires a bi-directional interaction between sender and receiver. This creates approximately 500 ms round trip time (RTT) in which a receiver is able to acknowledge (and possibly respond to) a sender's communication. It can be claimed that all of the difficulties experienced with the use of a broadband geosynchronous satellite can be traced back to this root cause of its relatively large propagation delay.

A user invokes a WWW transaction through the services of a software component known as a browser, such as Internet Explorer™ or Netscape Navigator™ as examples. The browser will interact with another software component known as a web server application (e.g., Apache™) that runs on an origin server. The interaction proceeds over the Internet using both UDP and TCP protocols for various elements of the overall transaction. The transaction may be decomposed into five distinct classes of sub-transactions. These are one or more DNS transactions, connection establishment transactions (i.e., SYN, SYN-ACK, ACK), HTTP transactions, TCP transfer transactions, and connection tear down transactions (i.e., FIN, FIN-ACK, ACK).

The term transaction here is being used with the implication that a transaction is an independent interaction that is both closed (i.e., has begin and end states) and consistent (i.e., begin and end states are valid states for the context). For a transaction to be closed over a communications link requires at least one sender-receiver interchange. For a broadband geosynchronous satellite, this implies a minimum of approximately 500 ms transaction time, which is the time in which the transaction remains open.

One important aspect of world wide web (WWW) transactions is the serial nature of several of the composing sub-transactions. The implication that one transaction cannot be started until a previous transaction is ended deprives the overall transaction of inherent parallelism. This is not to say that any sub-transactions are serialized with all the other sub-transactions, there are in fact many opportunities for parallelism in some cases of HTTP transactions and in most case of the TCP transfer transactions.

Content distribution services (CDSes) serve the function of moving a copy of the origin data to a replicated copy “nearer” the requester. The replicated copy is stored on various content distribution mirrors (CDMs) spread across the Internet to increase the likelihood one is proximate to the requestor. The requester receives content from the mirrored copy just like it was the origin server. The origin server or some service provider manages the update of all distribution servers when content changes on the origin server.

### BRIEF SUMMARY OF THE DISCLOSURE

This disclosure describes the concept of pre-caching to include pre-fetches as well as any other techniques that convey content to one or more caches in advance of any expected or anticipated use. In one embodiment, a parameterization filter determines which HTTP objects are parameterized (i.e., customized for a particular user) and which are not. Those that are unparameterized are kept in a basestation cache. The unparameterized objects are distributed to a number of satellite modem caches for user's who might want that content. In one embodiment, the basestation knows what is in each of the modem caches throughout the system and manages the content of that cache.

In one aspect, multicasting can be used to distribute the pre-fetched content. Content that is requested by a user that is likely to be used by other users, is multicast to a group of satellite modems. All users associated with the group can potentially benefit should from the multicast information should they also select the same content pre-stored in their CPE.

For those users likely to use a particular web site, the satellite modem can be configured like a content distribution service (CDS) that pre-populates a cache for those particular web sites. A mini-CDM function is configured to pre-store content sent directly from the CDS on behalf of a particular origin server. The CDS can determine and control what is stored on each cache to speed access. Some embodiments could put the CDM in application software instead of the satellite modem.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B are block diagrams of embodiments of a wireless broadband system;

FIGS. 2A, 2B and 2C are block diagrams of embodiments of a satellite modem;

FIGS. 3A, 3B and 3C are block diagrams of embodiments of a satellite gateway;

FIG. 4 is a flow diagram of an embodiment of a process for supplying a content object over a satellite link; and

FIG. 5 is a flow diagram of an embodiment of a process for distributing content to mini-content delivery mirrors (CDMs).

### DESCRIPTION OF THE SPECIFIC EMBODIMENTS

Generally, HTTP pre-fetching has weaknesses that makes it unattractive for inclusion in a system such as broadband satellite system. Accordingly, embodiments described below overcome or reduce these weaknesses to make certain forms of pre-fetching effective. In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

More particularly, the concept of pre-caching is introduced to include effective pre-fetches as well as other techniques that convey content, at no cost, to one or more caches in advance of any expected or anticipated use. The improvements that come from pre-caching are then estimated. In addition for effective pre-fetching, multicasting is implemented as a feature used to extend the access speedup and bandwidth savings benefits of pre-caching in the satellite broadband system.

As disclosed herein, “HTTP Pre-fetching” or pre-fetching may refer to retrieving objects before they are actually requested and moving them as close to the user (browser) as possible. Pre-fetching can be further understood in two classes: anticipated and expected access. Expected access is a retrieval that can be determined by the reference to it in a previous access (i.e., an embedded object that is part of a requested web page) and is therefore certain to be needed unless the user cancels. Anticipated access is a retrieval that is based on some stochastic model to predict a future request by a user (e.g., a link in a requested web page, a commonly entered URL, etc.).

The term “effective” is used to mean various optimizations that provide an overall access speedup or bandwidth savings in the entire system rather than for only one user. An optimization that causes a gain for a single user, but a loss for many other users and a net loss in the entire system would thus could be termed ineffective.

“Parameterization” is the individualized results of an HTTP GET that are produced by the inclusion of a set of variable conditions to a base HTTP. Different variable conditions for a base HTTP GET provide “parameterized” results if the results are different. If the result is not different, the results are considered un-parameterized. “HTTP Pre-caching” or pre-caching is a modified form of pre-fetching to make it effective because bandwidth is less likely to be wasted. More generally pre-caching is any technique used to convey content to a cache at no cost in advance of any expected or anticipated use. Multicasting is a method of sending data simultaneously to a group of one or more pieces of customer premise(s) equipment (CPE), for example a satellite or wireless modem. Note that a CPE may be in more than one multicast group.

The term “Storage medium” may represent one or more devices for storing data, including read only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine readable medium such as storage medium. A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

One problem with pre-fetching may be that it has the almost certain risk of wasting bandwidth, its best case is that it simply wastes zero bandwidth. In the worst cases, the “wasted” bandwidth could actually slow the access times due to the excess load instead of speed them up. In fact, the worst case amount of bandwidth wasted is not obviously bounded, so it makes implementing pre-fetching a risky system design decision. Accordingly, by avoiding waste of any bandwidth, system optimizations may be effective.

It can be shown that P(u), or probability of use, needs to be high to actually gain an effective improvement in system performance. P(u) may, in fact be low (e.g., 0.001) with pre-fetching; and worse yet, P(u) could be arbitrarily low. Given that 1/P(u) is the mean number of pre-fetches required to achieve 1 successful pre-fetch; then on average, 1/P(u)−1 pre-fetches are wasted. The sum of these wasted pre-fetches from all users negatively affects the overall system by increasing the load on the forward link (thus increasing average queuing delay for all users of the forward link or alternatively reducing the total number of users the system can successfully serve). To avoid significant bandwidth waste on the forward link, therefore, P(u) should be high.

The P(u) is affected by constraints such as parameterized content pre-fetched in correctly—that is using the wrong parameters, content already located at the client side browser cache and objects with directives that disallow caching (and implicitly make pre-fetching ineffective, e.g. no-cache). All of these effects reduce P(u) significantly. Intelligent handling of these conditions and thereby increasing P(u) is one goal that is part of effective pre-fetching.

Pre-caching is the method of conveying content to a cache at approximately no cost. The implication of pre-caching is that any consumption of bandwidth is already accounted for by other reasons—such as the conventional delay associated with relaying of the response to a request. Pre-caching further implies that the latency of this conveyance is less than or equal to the latency of the natural method.

In one embodiment, the pre-fetching is modified by including a “parameterization filter” that can distinguish content that is parameterized from that which is not. The portion that is not parameterized is then candidate content to be pre-cached for the speed up benefit of a particular user.

In addition to a parameterization filer, the content of all caches are determinable in one embodiment. The size of the CPE cache is greater than or equal to the size of the browser cache (or caches), and the size of the gateway cache is sufficiently large so as to contain all unique items stored in the CPE caches for this embodiment. With a parameterization filter and cache determinability, it is believed a P(u)=1 may be achieved for expected accesses. The CPE cache size could be on the order of 10's to 100's of Megabytes for today's environment.

Optionally, a no-cache “override” filter may also be able to be implemented at the gateway to accelerate redirects and other similar requests that ordinarily include a “no-cache” directive from the origin server. Additionally, other methods of determining high P(u) cases can be, but is not limited to, encoding parameters used by HTTP GETs, Application types etc. The gateway agents (use to filter and determine parameterization) may choose to use elements of previous requests to determine parameters of future requests. In this way, “no-cache” content may none the less cached. Additionally, the gateway agent can crawl web sites trying different variations of URIs to characterize parameters in the URI that are not needed to identify a particular content object.

In one embodiment, the Gateway has processes to implement parameterization filtering and the acceleration of expected HTTP GET requests. A replication protocol could be used in lieu of a cache coherency protocol so that the knowledge of the CPE cache is known by the gateway at all times. With such an approach the CPE and gateway could handle various conditions such as in-flight satisfaction of outstanding requests with the concomitant flushing of unnecessary transmission and receptions.

Multicasting is a technique that can be used in some embodiments. The use of multicasting on the forward channel would allow multiple CPEs the opportunity to receive information using the bandwidth required to send to only one CPE, thus saving bandwidth and possibly saving access time for users. Generally speaking, multicasting will not waste bandwidth since a unicast to a requesting user and a multicast to a group of users should consume about the same amount of bandwidth. In such cases, multicasting will cause the system to always have the bandwidth savings of ≧0 (within one gateway and its subscribers) even without pre-caching. A small amount of overhead traffic is potentially used for multicast group membership configuration depending upon the scheme chosen.

When pre-cached elements are multicast, the no cost aspect of pre-caching is potentially extended to other listeners in the group. In this case the P(c), or probability of collateral use, need not be very high to obtain some advantage.

In one embodiment, miniature content distribution mirrors (mini-CDMs) are deployed at gateways and/or the CPE. A mini-CDM at the gateway would speed up web access by eliminating terrestrial Internet access delays of around 50-200 ms per access for content that is already distributed via a CDS, for example. A mini-CDM in the CPEs would further enhance performance by avoiding the satellite link in many cases.

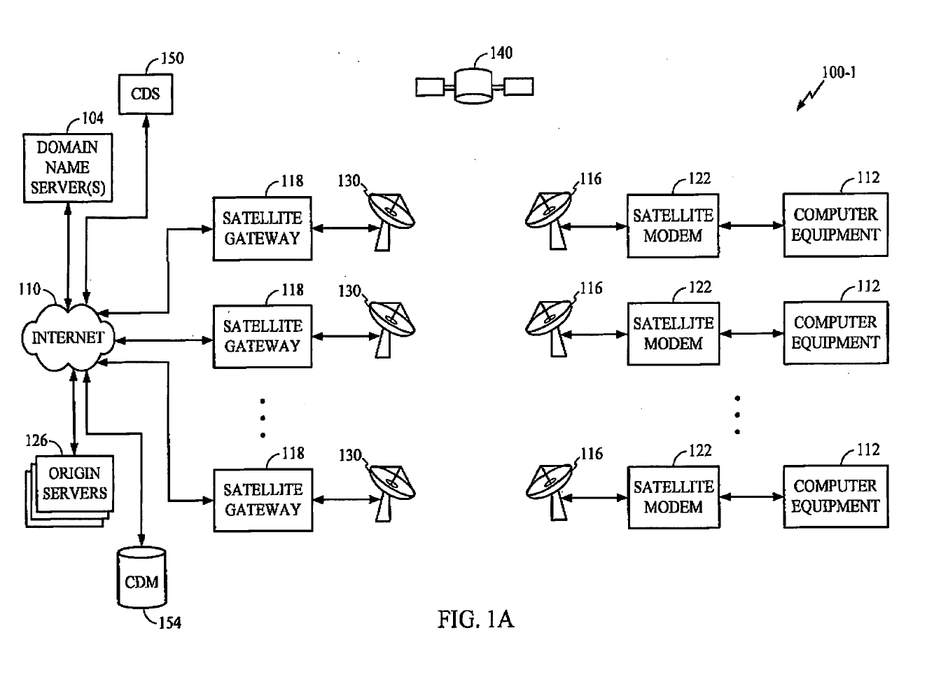

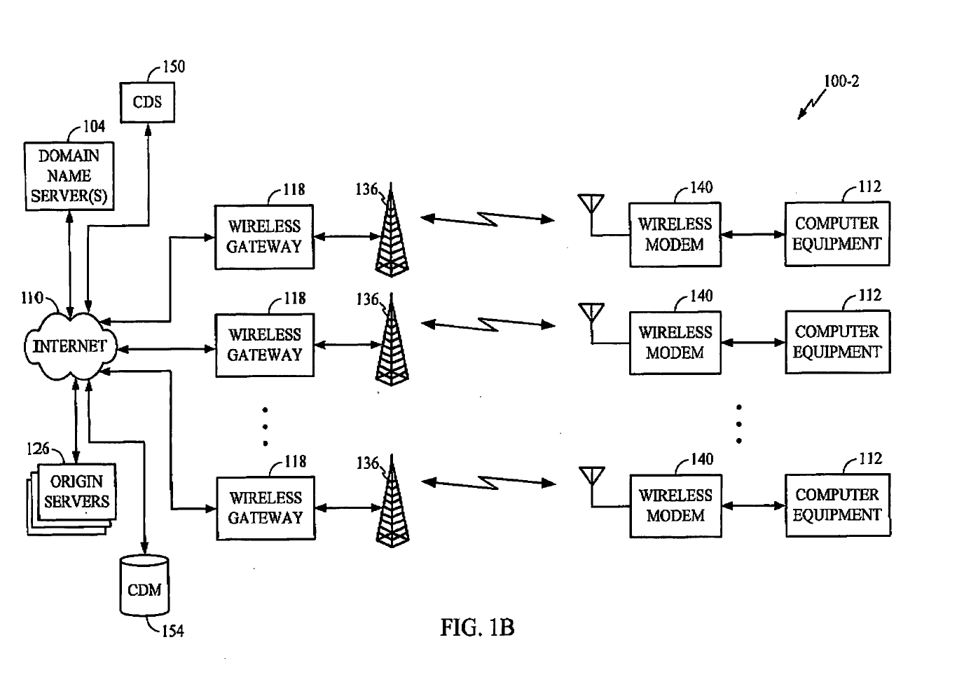

Referring initially to FIG. 1A, a block diagram of an embodiment of a wireless broadband system 100-1 is shown that utilizes a satellite link. A geosynchronous satellite 140 couples a first satellite dish 116 with a second satellite disk 130 in a bi-directional manner. Latency in each direction of this bi-directional link is about 250 ms, but never less than 100 ms or 200 ms in various embodiments. Some embodiments use the satellite link in a single direction and some other media for the other direction, for example, a dial-up modem connection. One embodiment uses a constellation of low earth orbit satellites that are not geosynchronous in the satellite link. In another embodiment, multiple satellites can route amongst themselves before downlinking to a gateway or ground station 118.

The wireless broadband system 100 allows computer equipment 112 of a user or business to communicate with the Internet 110. The computer equipment 112 could include any personal computers, mainframes, workstations, VOIP terminals, PDAs, consumer equipment, business machines, networks, video equipment, etc. that might communicate with the Internet 110 by way of the modem 122. Included in the computer equipment 112 is at least one web browser application. The web browser is configured to use an explicit proxy which could be limited to a protocol used by the web browser by the computer equipment 112. In some embodiments, the explicit proxy could sift through all the TCP/IP information to select the web browser information.

The computer equipment 112 communicates with a satellite modem 122. Collectively, the computer equipment 112 and the modem 122 are included in the CPE. The satellite modem 122 appears as an explicit proxy to the computer equipment. The web browser or operating system may have to be configured to use the satellite modem 122 as a proxy. Although the satellite modem 122 appears as a proxy to the computer equipment 112, the proxy functions are split between the satellite modem 122 and the satellite gateway 118 as explained further below.

The satellite modem 122 in this embodiment is a stand-alone unit. It includes software, hardware and one or more processors that implement the functionality of the modem 122. Storage could be in the form of volatile or non-volatile memory. The cache(s) in the modem 122 could be implemented in non-volatile magnetic or optical memory or volatile solid-state memory. In some embodiments, the cache(s) are lost upon power loss. The gateway 118 is notified upon power-up that the cache(s) have been cleared and a process begins to repopulate the pre-storage. In some embodiments, the cache(s) could be moved from the modem 122 to the computer equipment 112 and operate with software.

The satellite modem 122 includes ports to communicate with the computer equipment 112 and the satellite dish 116. The port(s) for the computer equipment 112 could include USB, ethernet, IrDA, Firewire, WiFi, UWB, WiMax, carrier current, etc. for various satellite modem 122 configurations. The satellite port allows communication with the satellite dish 116. RF signals are typically used for this port, but some embodiments could use a digital interface.

The satellite gateway 118 communicates between the satellite dish(es) 130 and the Internet 110 to service Internet requests of the computer equipment 112. Various embodiments could have a number of satellite gateways 118 distributed in various ways. One embodiment could receive the requests from various locations and send them to a gateway 118 at some remote location. Other embodiments could use a gang of gateways to divide the requests. Any other configuration is possible to perform the functions of the satellite gateway 118.

Implementation of the satellite gateway 118 can take any number of configurations. Computers and servers implement all the digital processing and storage tasks. Routers, switches, gateways, and modems are used to interface with the Internet and various components of the satellite gateway 118. Portions of the satellite gateway 118 can be spread over a geographically disparate network. The RF functions to interface with the satellite dish 130 or other wireless equivalents are implemented in hardware devices designed for that purpose.

Standard Internet requests are posed by the satellite gateways 118 to the Internet 110. Domain name servers (DNS) 104 are used to translate domain names into Internet protocol (IP) addresses. The IP addresses correspond to origin servers 126 that serve up the object indicated in a uniform resource identifier (URI). A content delivery service 150 maintains a content delivery mirror(s) 154 on the Internet to speed content delivery from one or more origin servers 126. Although not shown, other variations of the Internet configuration are possible. For example, the origin server 126 may use multiple content mirrors and/or content delivery networks.

With reference to FIG. 1B, a block diagram of another embodiment of the wireless broadband system 100-2 is shown that utilizes a wireless cellular link. The wireless modems 140 could be plug-in cards that allow various types of computer equipment 112 to communicate with the wireless gateways 118 without necessarily having phone capabilities. In one embodiment, both the wireless modem 140 and computer equipment 112 are integrated into a telephone handset with browser capabilities. Each wireless gateway 118 is coupled to a cellular base station 136 that wirelessly couples to the wireless modem 140. The latency of the cellular link is substantially less than a satellite link in most cases.

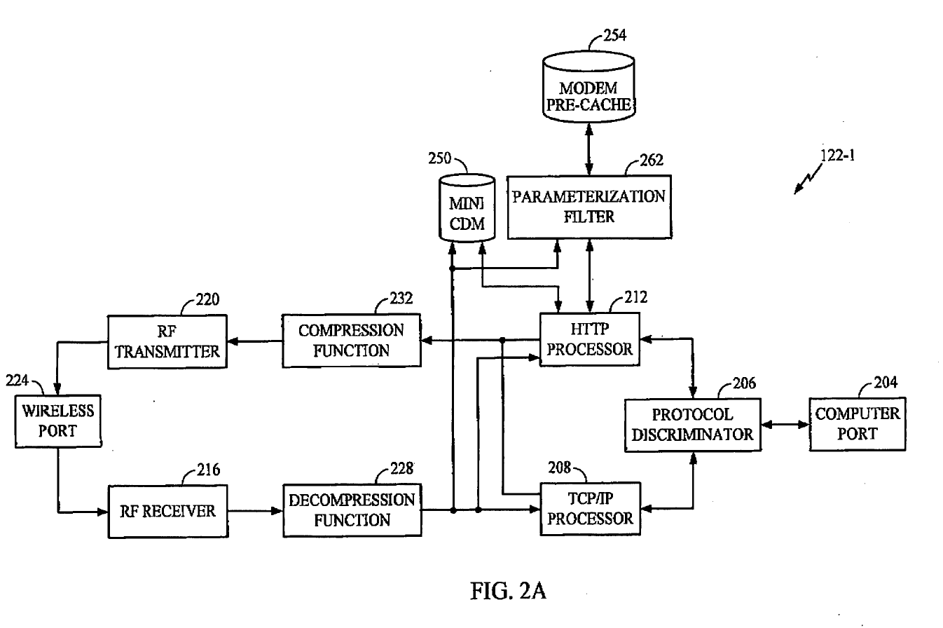

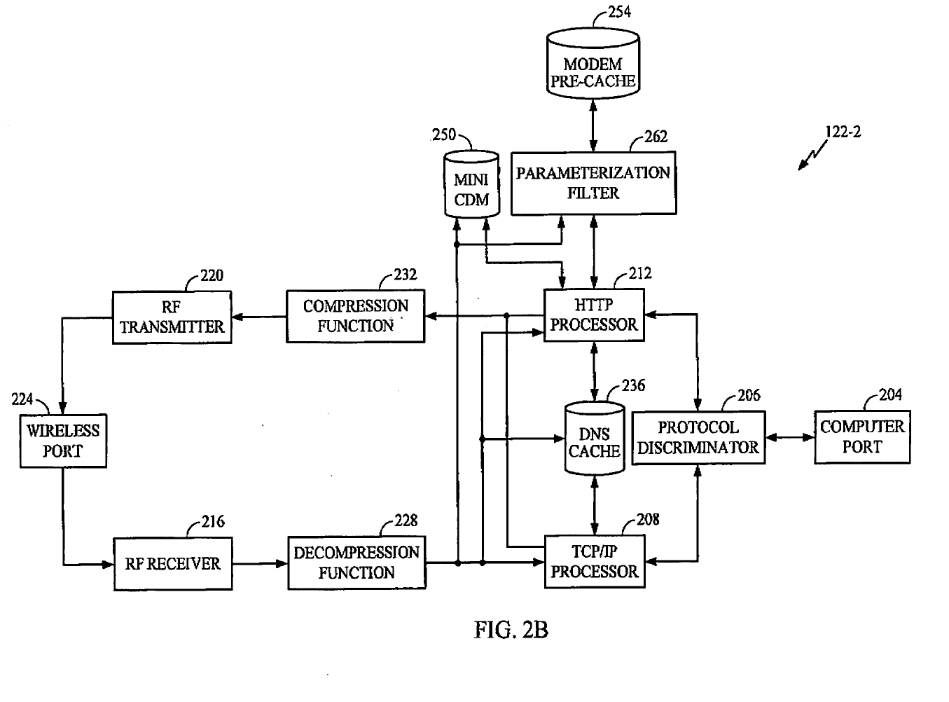

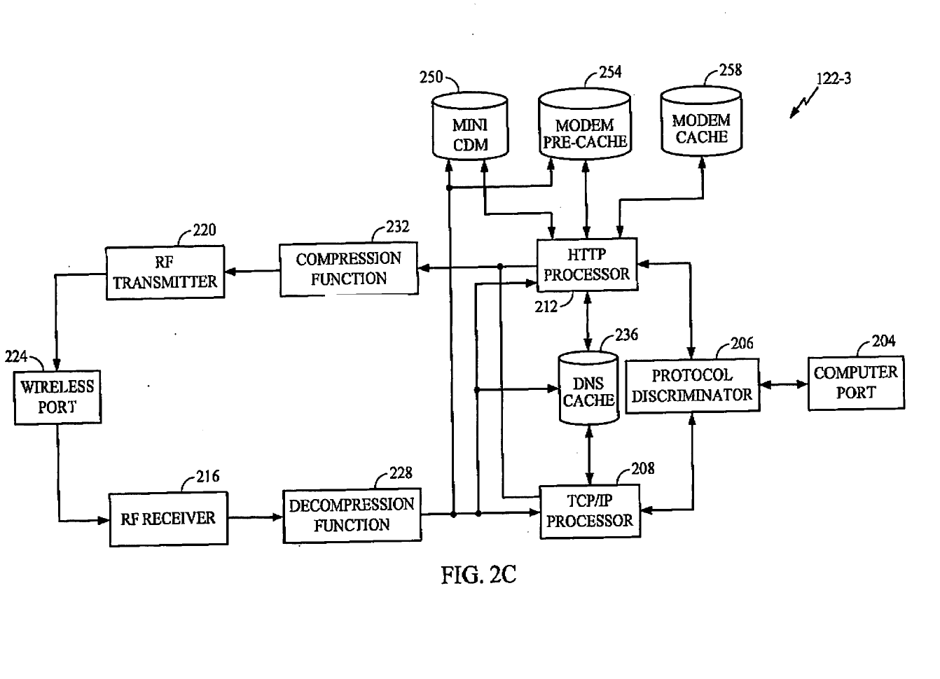

Referring next to FIG. 2A, a block diagram of an embodiment of a satellite or wireless modem 122-1 is shown. A computer port 204 communicates with the computer equipment 112, but other embodiments could support a number of different wired or wireless ports 204 and protocols. A protocol discriminator 206 manages all the TCP/IP traffic of the computer port 204. HTTP type traffic is kept separate from other TCP/IP traffic by the protocol discriminator 206. IP address, port or other mechanisms could be used to keep the HTTP traffic separate from the remainder of the TCP/IP traffic. In any event, the protocol discriminator 206 communicates the HTTP traffic to the HTTP processor 212 and the remaining TCP/IP traffic to the TCP/IP processor 208.

The TCP/IP processor 208 handles Internet traffic that is not HTTP traffic. Some embodiments may enhance the handling of non-HTTP traffic using some of the techniques described herein. The TCP/IP processor 208 communicates over the wireless link in compressed form by using the compression and decompression functions 232, 228. The radio frequency (RF) transmitter 220 and RF receiver 216 modulate and demodulate digital signals onto a carrier frequency. Other embodiments may have different RF configurations.

The HTTP processor 212 manages the HTTP traffic. When HTTP traffic is detected, a TCP connection between the satellite modem 122 and satellite gateway 118 is opened by the HTTP processor in both the forward and return links. After a period of inactivity, this TCP connection could be closed, for example, after 20 minutes. Presuming no inactivity period has triggered a disconnect, many different HTTP transactions will flow through the TCP link. A conventional system would set-up and tear-down a TCP link for each HTTP transaction.

Some embodiments could use protocols other than TCP for the return link. These protocols are configured in advance of receiving the HTTP transaction and remain open to service many HTTP transactions. Typically, a RTT delay is required to configure the protocol for the return link, but this embodiment only suffers that RTT delay the first time the return link is configured.

The HTTP processor 212 gathers HTTP GETs from the computer equipment 112 and supplies the corresponding HTTP REPLY. When a domain name look-up is presented to the HTTP processor 212 a fabricated IP address is returned to the web browser. The fabricated IP replaces the domain name in the URI and is presented to the HTTP processor 212 for downloading the web page. At that point, the HTTP processor 212 sends the URI with the domain name instead of the fabricated IP address on the return link to the satellite gateway 118 using the previously opened TCP link. When the actual web page returns, the HTTP processor substitutes the fabricated IP address for the web browser. The gateway 118 may indicate the actual IP address for the domain name to facilitate DNS caching found in some embodiments.

The forward and return links use compression to reduce the bandwidth requirements. The compression algorithm is tailored to the specific data in this embodiment. For example, one algorithm may be used for text and another for files. The data passing through the return link is largely text such an effective textual algorithm is used, for example, Lempel-Ziv. The forward link may use another algorithm that is effective for textual and non-textual information. In any event, but the compression and decompression functions 232, 228 use lossless compression in this embodiment. The compression and decompression functions 232, 228 could be implemented in hardware and/or software. Where multiple algorithms are used, a header for the compressed data can indicate which algorithm was used for the compressed data to allow the receiving end of the link to decompress the data.

This embodiment includes two caches that are pre-populated with content likely to be requested by the computer equipment 112. Before requesting a content object from the gateway 118, the HTTP processor 212 checks these two caches. The first is a mini-CDM 250 that holds content that one or more CDS 150 has specified for transmission to selected modems 122.

The content stored on the mini-CDM 250 mirrors content on one or more origin servers 126. Periodically, the content is sent to a group of modems 122 by one or more CDS 150 using a multicast broadcast. The CDS 150 has algorithms and techniques to determine the content objects most likely to be requested by each modem 122. This determination may take into account past browsing habits of users of the modem 122. Each content object in the mini-CDM has a URI associated with it. When the HTTP processor 212 receives a HTTP GET, the associated URI is presented to the mini-CDM 250 to check for a match. The mini-CDM 250 ignores the parts of the associated URI that holds parameters not needed to match the associated URI with a URI for a content object in the mini-CDM 250.

The modem pre-cache 254 stores content objects that other modems 122 have requested and are likely to be requested by this modem 122-1. The web browsing requests by each modem 122 are monitored in the gateway 118 to allow determining which sites are of interest. When other modems 122 request unparameterized content the gateway may fulfill that request in a multicast to a number modems 122 likely to use that site. All those pre-stored content objects are stored in the modem pre-cache 254.

Often a URI presented to the modem in a HTTP GET will have embedded parameters unique to the particular user and/or web browser. For example, passwords and cookies are often embedded in the URI. These embedded parameters are not necessary when gathering the content object. In this way, a particular content object could be identified by many different URIs. A parameterization filter 262 is aware of the portions of the URI that hold embedded parameters unrelated to the specified content objects. When a URI is presented to the parameterization filter, a transformation is performed to mask these embedded parameters when checking the modem pre-cache 254 for the content object.

The parameterization filter is updated periodically by the gateway 118 with new filtering rules. The rules are developed in many different ways by an automated agent, but some embodiments could be aided by individuals. By observing different URIs returning the same content object, the agent can determine the portions of the URI that does not add anything to the content object identification. Further, the agent can query the origin server with various URI permutations to determine which embedded parameters can be removed. Often the tools used to design or deliver the content the origin server define embedded parameters in the same way such that the filtering rules developed for one site can be imputed to other sites that seem to use the same tools.

With reference to FIG. 2B, a block diagram of another embodiment of the satellite or wireless modem 122-2 is shown that includes a DNS cache 236. The DNS cache 236 is used by the HTTP processor 212 and TCP/IP processor 208 to hold previously obtained DNS look-ups that used the gateway 118. When a web browser or other application requests a DNS look-up, the DNS cache can be referenced to determine if it has been determined previously. Any cached IP address can be used for a subsequent DNS look-up operation.

Referring next to FIG. 2C, a block diagram of yet another embodiment of a satellite or wireless modem 122-3 is shown that includes a mini-CDM 250, a modem pre-cache 254 and a modem cache 258. This modem cache 258 includes the prior content objects requested by the web browser. Subsequent attempts to request the same content object can be satisfied by the modem cache 258 should the content object still be stored. Some embodiments could mask away the parameters in the URI not needed to uniquely identify the content object stored in the modem cache 258 to make it more likely the modem cache 258 could provide the content object.

The modem cache 258 could have any size, but in this embodiment, the size is larger than any web browser cache and smaller than any cache in the gateway 118. Although the mini-CDM 250, the modem pre-cache 254, and modem cache 258 are shown as being separate, some embodiments could combine these in a single cache where the CDS 150, other modems 122 or the web browser variously influence the contents.

The modem pre-cache 254 in this embodiment is shown without a parameterization filter. The URIs for the stored content object have their unnecessary parameters screened out at the gateway 118 such that subsequent checks of modem pre-cache 254 will not consider the masked parameters. For example, a first URI of “DomainA/cookie/password/path/filename” could be listed in the modem pre-cache 254 as “DomainA/*/path/filename” to indicate any character(s) could replace the “*” character and still be considered a match to the associated content object.

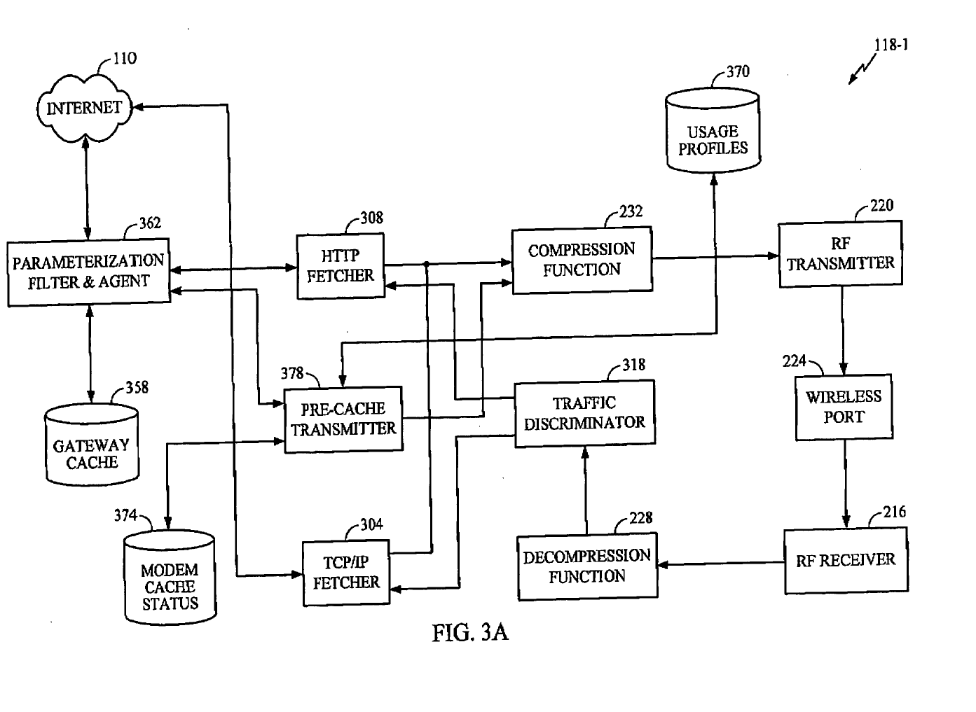

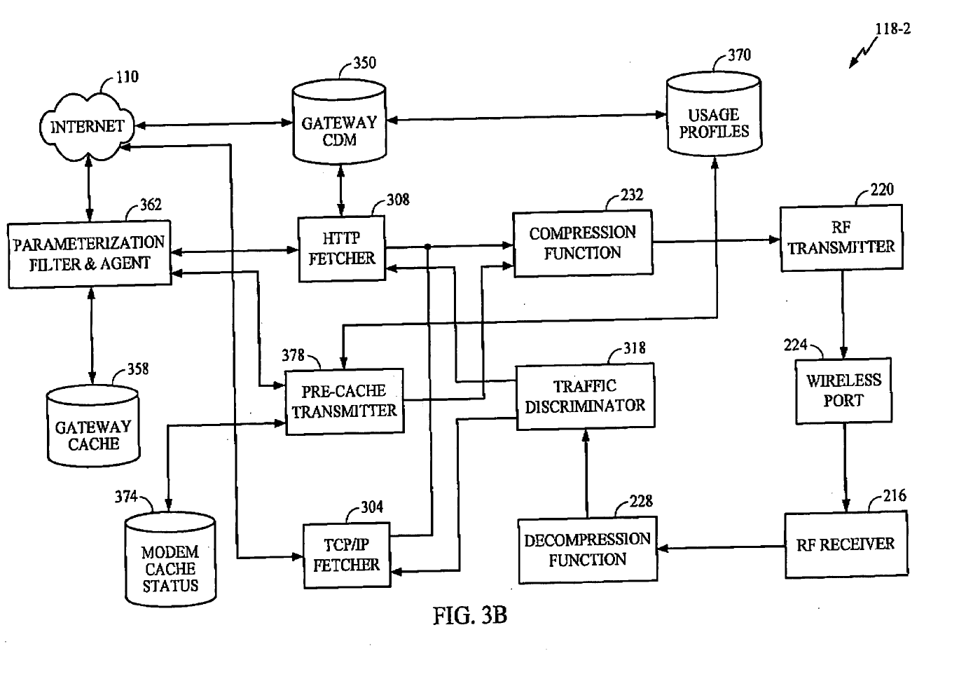

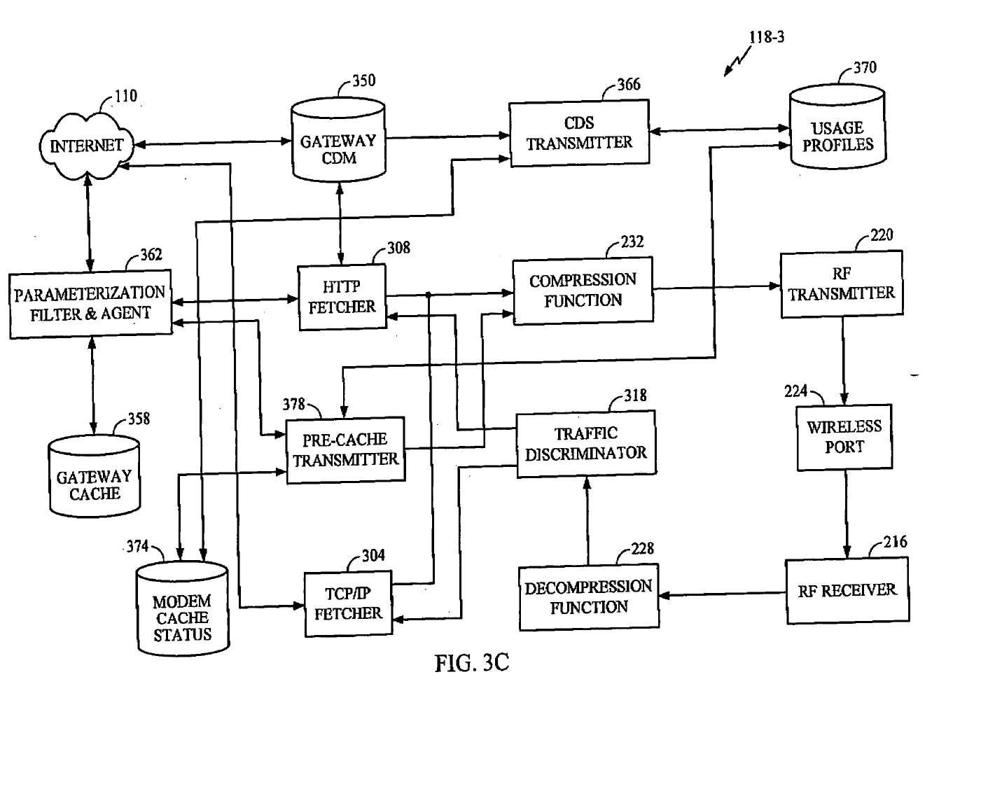

With reference to FIG. 3A, a block diagram of an embodiment of a gateway 118-1 is shown that has an ability to pre-cache with the modems 122. The depicted embodiment uses the compression function 232, the decompression function 228, the RF transmitter 220, the RF receiver 216, and wireless port 224 in a configuration that mirrors the wireless modem 122. Once information from the return link is demodulated and decompressed, a traffic discriminator 318 determines if the information is HTTP related. The HTTP fetcher 308 handles the HTTP traffic and a TCP/IP fetcher 304 handles the remainder. Both HTTP and TCP/IP fetchers 308, 304 interact with the Internet 110 to gather and return Internet information for the forward link to the modem 122.

The HTTP fetcher 308 decodes the URIs with their domain names that are received from the modem 122. The domain name is translated to an IP address using a DNS 104 on the Internet 110. Once the IP address is known, the URI is issued to the particular origin server 126 to provide the HTTP web page. Once the web page is returned to the HTTP fetcher 308, the embedded objects linked from the web page are also downloaded by the HTTP fetcher 308. The web page and embedded objects are compressed and sent on the forward link as they arrive. Some embodiments of the HTTP fetcher 308 follow all the links on the web page and also send those linked pages to the HTTP processor 212 in anticipation of one of the linked pages being requested.

This embodiment includes a gateway cache 358 and a parameterization filter and agent (PFA) 362. The HTTP fetcher 308 requests content objects through the PFA 362. The PFA 362 first masks parameterized portions of the URI if present. The masked URI is checked against the URIs for the content objects stored in the gateway cache 358. Instead of masking the URI of the requested content object, some embodiments could mask the URIs of the content objects. In some cases, a particular content object may have several different variations of URIs. For example, a certification icon may appear on many different web sites. The PFA 362 can map the requested URI to one stored in the gateway cache 358 even if the path and domain of the cached URI isn't the same.

Where a requested URI cannot be matched to a cached URI, the origin server 126 is queried over the Internet 110. The PFA 362 adds the returned content object to the gateway cache 358 if it is determined that the content object is not unique to the requesting web browser, i.e., if the content object is unparameterized. Where it is determined that the content object already matches a content object already stored in the gateway cache 358, the agent portion of the PFA 362 notes the unnecessary request from the origin server 126 and adjusts the parameterization filter portion of the PFA 362 so a similar mistake will not be made in the future.

Where the content object is unparameterized, it is passed to a pre-cache transmitter 378 for return to the requesting modem 122. Parameterized content objects are passed to the HTTP fetcher 308. The pre-cache transmitter 378 knows what is stored in all the modem pre-caches 254 and mini-CDMs throughout the system 100 by referencing that information in a modem cache status database 374. By referring to usage profiles 370, the pre-cache transmitter 378 can further determine which modems 122 are likely to request the unparameterized content object. In addition to the requesting modem 122, those modems 122 likely to request the content object in the future are included in a multicast group. Each modem 122 in the multicast group receives the content object and adds it to their modem pre-cache 254. The HTTP processor 212 for the requesting modem 122 will return the content object to the web browser. The modem cache status database 374 is updated after any unparameterized content object is sent to one or more modems 122.

Referring next to FIG. 3B, a block diagram of another embodiment of a gateway 118-2 is shown that includes a gateway CDM 350. In addition to a CDS 150 having a CDM 154 across the Internet 110, a gateway CDM 350 may also be maintained by the CDS 150. The gateway CDM 350 and/or CDS 150 have an awareness of what individual modems 122 are requesting by reference to usage profiles 370. The gateway CDM 350 is populated with an understanding of the likely requests of the modems 122. The usage profiles 370 are continually updated as the gateway 118 fulfills requests such that the CDS 150 can update the makeup of the gateway CDM 350.

With reference to FIG. 3C, a block diagram of yet another embodiment of a gateway 118-3 is shown that includes support for mini-CDMs 258 in the modems 122. A CDS transmitter 366 communicates with the usage profile database 370 to determine how best to keep mini-CDMs 250 full for all modems 122 that have that capability. The CDS transmitter 366 can add content objects in singlecast or multicast fashion. Also, content objects can be removed from each of the mini-CDMs 258 with a message that can be singlecasted or multicasted. As content changes on the origin servers, the CDS transmitter 366 keeps the mini-CDMs 250 current.

Periodically, the modems are expected to cycle power and those that hold their mini-CDM 250 in volatile memory are updated with periodic multicast of all content objects that might be relevant. The most popular content objects are sent with greater frequency than the less popular content objects. During periods of high activity on the satellite or wireless link, these periodic updates can be suspended temporarily.

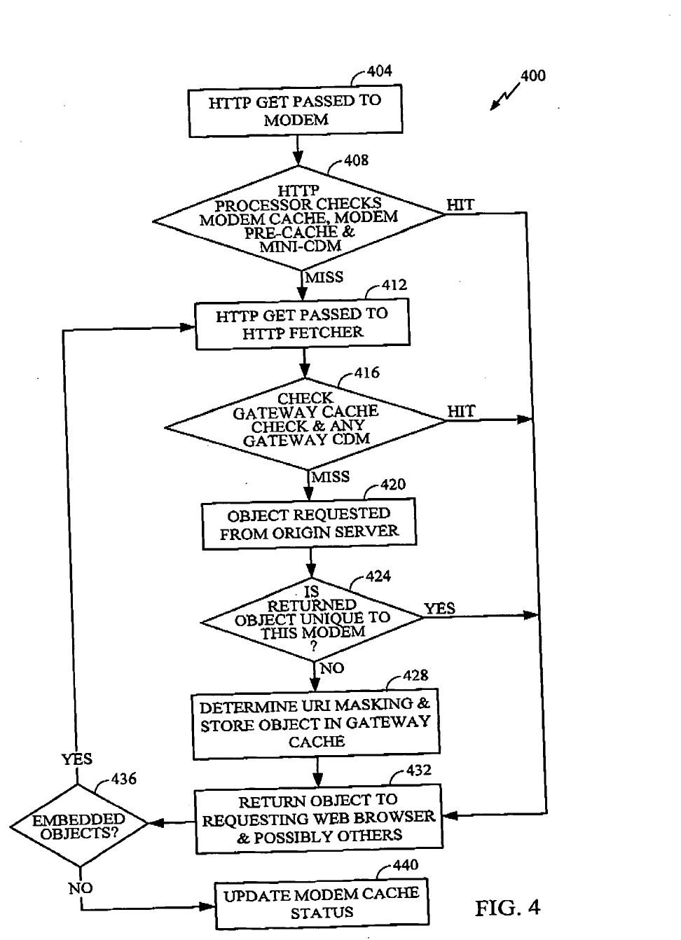

Referring next to FIG. 4, a flow diagram of an embodiment of a process 400 for supplying a content object over a satellite link is shown. The depicted portion of the process 400 begins in step 404 where a HTTP GET is passed from a web browser to the modem 122. Various configurations may include a mini-CDM 250, a modem pre-cache 254 and/or a modem cache 258 which are checked in step 408 if available. If the content object is found in the modem 122, processing skips ahead to step 432.

Where the content object cannot be located by the HTTP processor 212 in the modem 122, processing continues to step 412 to fulfill the HTTP GET. More specifically, the request is passed by the HTTP processor 212 to the HTTP fetcher 308 in the gateway 118. In step 416, the gateway cache 358 and any gateway CDM 350 are checked for the content object. If found, processing continues to step 432. In light of the request, the pre-cache transmitter 378 may consider broader distribution of the content object.

If the content object is not stored in the modem 122 or the gateway 118, a request is made to the origin server 126 in step 420. The IP address for the domain in the URI is found with a DNS cache 236 or a domain name server 104. Transparent to the gateway 118, a CDM 154 may actually serve up the content object. Once the content object returns, a determination is made by the PFA 362 based upon the original URI and the returned object as to whether the object is parameterized or not in step 424. Where it is unique to the requesting modem 122, processing skips ahead to step 432 and the content object is passed back to the requesting modem 122. The requesting modem may wish to add this object to the modem cache 258 to speed subsequent requests. Some of the parameters in the URI could be masked or removed prior to storage in the modem cache 258 to increase the likelihood a subsequent request for the same content object will be fulfilled by the modem cache 258.

Where the content object is unparameterized, the URI is masked by the PFA 362 and the content object is stored in the gateway cache 358 in step 428. In step 432, the content object is passed back to the requesting modem 122. Where the content object is unparameterized, alternatively, it may be multicast to a number of modems 122 that include the requesting modem 122. The multicast group would store the content object in the modem pre-cache 254. Since each of the modem pre-caches 254 is likely smaller than the gateway cache 358, only some of the unparameterized content objects are sent to populate the modem pre-caches 254 of the multicast group.

Where the content object has embedded objects, as determined in step 436, processing loops back to step 412. The HTTP fetcher 308 finds and returns the embedded object, which could have further embedded objects. In any event, the gateway 118 recursively processes the original HTTP GET to find and send all content related to the original HTTP GET regardless of whether the requesting modem 122 has asked for it. After all the content objects have been provided by multicast or singlecast to the modems 122, the modem cache status database 374 is updated if not done already.

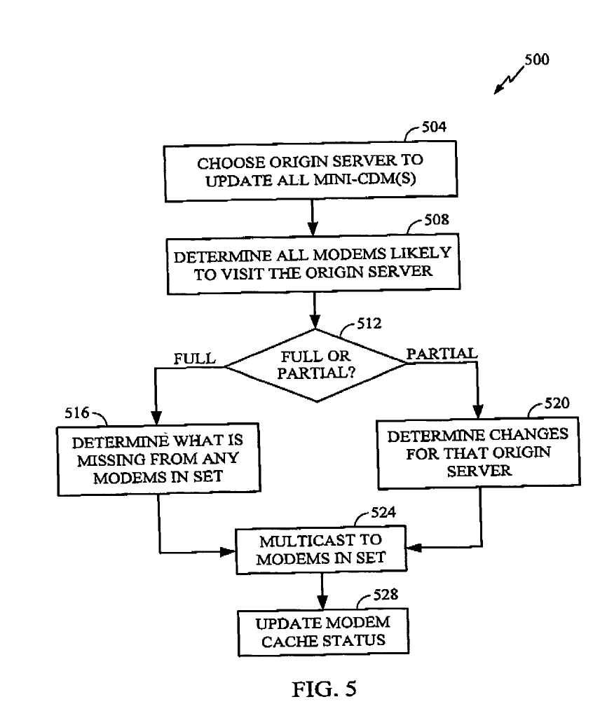

With reference to FIG. 5, a flow diagram of an embodiment of a process 500 for distributing content to mini-CDMs 258 is shown. The CDSes 150 and/or CDS transmitter can make a determination of which origin server domains to update in step 504. In one embodiment, there are multiple CDS 150 that are each responsible for one or more origin servers. Some of these CDSes 150 could be allowed by the gateway 118 to load content on the mini-CDM 250. The CDSes 150 could be billed for their usage of the mini-CDM and or gateway CDM. The gateway 118 could include multiple gateway CDMs and CDS transmitters 366 that each support one or more CDS 150. Alternatively, all CDSes 150 could share these resources.

In step 508, the CDS 150 determines which modems 122 are likely to browse their origin server(s) 126. The usage profiles 370 maintained for each modem 122 can be referred to for this information. A set of modems 122 is chosen that could benefit from mini-CDM 250 holding content objects for a particular origin server.

As shown in step 512, the CDS 150 can do a full or partial distribution of the content objects deemed worth storing in mini-CDMs 250. A partial update as performed in step 520 only includes recent changes to the origin server. The additions and deletions to the mini-CDM 250 could include added content, deleted content, old content that is now popular, old content that is no longer popular. Less frequently than the distribution of changes, all the content objects currently relevant could be sent in step 516. Full distribution populates mini-CDM that have lost content objects due to errors or power loss. The full or partial distributions could be delayed when the wireless link to the modems 122 is overloaded.

In step 524, the content objects are multicast to the modems 122 in the defined set. In step 528, the modem cache status database 374 is updated to reflect the content currently stored in the mini-CDM 250 for each modem 122. In this way, the origin servers 126 can have content pushed to modems 122 likely to use the content.

It should be noted that the foregoing embodiments are merely examples and are not to be construed as limiting the disclosure. The description of the embodiments is intended to be illustrative, and not to limit the scope of the claims. As such, the present teachings can be readily applied to other types of apparatuses and many alternatives, modifications, and variations will be apparent to those skilled in the art.

1. A method for delivering a content object identified by a uniform resource identifier (URI) to a web browser coupled to the Internet over a satellite broadband link, the method comprising steps of:
checking a first cache in a modem that is associated with the web browser for the content object, wherein an exact match of the URI to cached content objects is not required for a first cache hit from the first cache;
passing the URI over the satellite broadband link to a gateway that is located remotely to the modem should the first-listed checking step not locate the content object in the first cache;
checking a second cache in the gateway for the content object, wherein an exact match of the URI to cached content objects is not required for a second cache hit from the second cache; and
requesting the content object from an origin server should the second-listed checking step not locate the content object in the second cache.

2. The method for delivering the content object identified by the URI to the web browser coupled to the Internet over the satellite broadband link as recited in claim 1, further comprising a step of multicasting the content object to a group of modems that includes the modem.

3. The method for delivering the content object identified by the URI to the web browser coupled to the Internet over the satellite broadband link as recited in claim 1, further comprising a step of determining a group of modems that may benefit from caching the content object.

4. The method for delivering the content object identified by the URI to the web browser coupled to the Internet over the satellite broadband link as recited in claim 1, further comprising a step of pre-loading the first cache with a plurality of content objects specified by a content distribution service associated with an origin server.

5. The method for delivering the content object identified by the URI to the web browser coupled to the Internet over the satellite broadband link as recited in claim 1, wherein portions of the URI are masked before the passing step is performed.

6. The method for delivering the content object identified by the URI to the web browser coupled to the Internet over the satellite broadband link as recited in claim 1, wherein the second cache is equal to or greater in size than all of a plurality of first caches in a plurality of modems.

7. The method for delivering the content object identified by the URI to the web browser coupled to the Internet over the satellite broadband link as recited in claim 1, wherein:
each of the cached content objects in at least one of the first and second caches has a cached object URI, and
at least one cached object URI has a field that is masked in any comparison with the URI.

8. The method for delivering the content object identified by the URI to the web browser coupled to the Internet over the satellite broadband link as recited in claim 1, further comprising a step of periodically performing a cache coherency routine so the gateway can determine what is stored in the first cache.

9. The method for delivering the content object identified by the URI to the web browser coupled to the Internet over the satellite broadband link as recited in claim 1, wherein the gateway knows the cached content objects that are stored in the modem.

10. A computer-readable medium having computer-executable instructions for performing the computer-implementable method for delivering the content object identified by the URI to the web browser coupled to the Internet over the satellite broadband link of claim 1.

11. A content gathering system for providing a content object to a web browser, the content gathering system comprising:
customer premises equipment (CPE) comprising a first cache;
a gateway remote to the CPE; and
a satellite link coupling the CPE to the gateway, wherein:
the gateway comprises a second cache, and
at least one of the CPE and the gateway comprises a parameterization filter that masks differences between a first URI of the content object and a second URI of a cached content object of the first or second cache.

12. The content gathering system for providing the content object to the web browser as recited in claim 11, wherein the parameterization filter removes portions of the first URI not necessary to uniquely identify the content object.

13. The content gathering system for providing the content object to the web browser as recited in claim 11, wherein each of a plurality of content objects in the second cache are stored in the second cache in response to a request from the satellite link.

14. The content gathering system for providing the content object to the web browser as recited in claim 11, wherein the CPE comprises a modem that includes the first cache.

15. The content gathering system for providing the content object to the web browser as recited in claim 11, wherein the CPE comprises a mini-content distribution mirror (CDM) populated under the control of a content distribution service (CDS) of an origin server.

16. The content gathering system for providing the content object to the web browser as recited in claim 15, wherein the mini-CDM is integral with the first cache.

17. The content gathering system for providing the content object to the web browser as recited in claim 11, wherein the gateway comprises a CDM under the control of a content distribution service (CDS) of an origin server.

18. The content gathering system for providing the content object to the web browser as recited in claim 11, wherein a CDS multicasts content objects to the first cache.

19. A content gathering system for providing a content object to a web browser, the content gathering system comprising:
means for checking a first cache in a modem that is associated with the web browser for the content object, wherein an exact match of the URI to cached content objects is not required for a first cache hit from the first cache;
means for passing the URI over the satellite broadband link to a gateway that is located remotely to the modem should the first-listed checking step not locate the content object in the first cache;
means for checking a second cache in the gateway for the content object, wherein an exact match of the URI to cached content objects is not required for a second cache hit from the second cache; and
means for requesting the content object from an origin server should the second-listed checking step not locate the content object in the second cache.

20. The content gathering system for providing the content object to the web browser as recited in claim 19, further comprising means for multicasting the content object to a group of modems that includes the modem.

21. The content gathering system for providing the content object to the web browser as recited in claim 19, further comprising means for determining a subset of modems that may benefit from caching the content object.

22. The content gathering system for providing the content object to the web browser as recited in claim 19, further comprising a step of pre-loading the first cache with a plurality of content objects specified by a content distribution service associated with an origin server.

23. The content gathering system for providing the content object to the web browser as recited in claim 19, further comprising means for periodically performing a cache coherency routine so the gateway can determine what is stored in the first cache.

24. A method for pre-storing content objects on a plurality of CPE, the method comprising steps of:
providing a CDS that distributes content objects for an origin server;
determining a subset of the plurality of CPE that are likely to request content from the origin server;
multicasting a plurality of content objects to the subset under the direction of the CDS, wherein the multicasting is performed with a satellite link that is coupled to the plurality of CPE; and
storing the plurality of content objects at the subset, wherein the plurality of content objects are available to the CPE for later request.

25. The method for pre-storing content objects on the plurality of CPE as recited in claim 24, wherein the storing step comprises a step of storing the plurality of content objects on a mini-CDM.

26. The method for pre-storing content objects on the plurality of CPE as recited in claim 24, wherein:
a URI requested by the CPE may have portions of the URI that match and portions that don't match a cached URI for a content object of the plurality of content objects, and
the content object is used to satisfy the URI.

27. The method for pre-storing content objects on the plurality of CPE as recited in claim 24, further comprising a step of updating the subset with changes on the origin server.

28. The method for pre-storing content objects on the plurality of CPE as recited in claim 24, wherein a URI of a content object requested by the CPE may only partially match one URI for the plurality of content objects before the one URI is used to retrieve the content object to satisfy the URI.

29. A computer-readable medium having computer-executable instructions for performing the computer-implementable method for pre-storing content objects on the plurality of CPE of claim 24.

30. A content gathering system for providing a content object to a web browser, the content gathering system comprising:
a plurality of customer premises equipment (CPE), wherein each of the plurality of CPE comprises a mini-CDM;
a gateway remote to the CPE;
a CPS coupled with the gateway and associated with an origin server; and
a satellite link coupling the plurality of CPE to the gateway, wherein:
the satellite link multicasts content objects to a subset of the plurality of CPE, and
the mini-CDM of the subset stores the content objects.

31. The content gathering system for providing the content object to the web browser as recited in claim 30, wherein the gateway knows what is stored on the mini-CDM.

32. The content gathering system for providing the content object to the web browser as recited in claim 30, further comprising a plurality of CPS, which includes the CPS, that share the mini-CDM.

33. The content gathering system for providing the content object to the web browser as recited in claim 30, wherein the CPS is billed for usage of the mini-CDM.

34. The content gathering system for providing the content object to the web browser as recited in claim 30, wherein each of the plurality of CPE further comprises a pre-cache that stores CPE-requested objects.

35. The content gathering system for providing the content object to the web browser as recited in claim 30, further comprising a cache coherency process that periodically updates the gateway with an inventory of the content objects stored on each of the plurality of CPE.

36. A content gathering system for providing a content object to a web browser, the content gathering system comprising:
a CDS that distributes content objects for an origin server;
means for determining a subset of the plurality of CPE that are likely to request content from the origin server;
means for multicasting a plurality of content objects to the subset under the direction of the CDS, wherein the multicasting is performed with a satellite link that is coupled to the plurality of CPE; and
means for storing the plurality of content objects at the subset, wherein the plurality of content objects are available to the CPE for later request.

37. The content gathering system for providing the content object to the web browser as recited in claim 36, further comprising means for updating the subset with changes on the origin server.

38. The content gathering system for providing the content object to the web browser as recited in claim 36, wherein a URI of a content object requested by the CPE may only partially match one URI for the plurality of content objects before the one URI is used to retrieve the content object to satisfy the URI.
